(19) United States
(12) Patent Application Publication
(10) Pub. No.: US 2022/0237578 A1
(43) Pub. Date: Jul. 28, 2022

(54) Multi-Computer Processing System for Dynamic Event Control

(71) Applicant: Bank of America Corporation, Charlotte, NC (US)

(72) Inventors: Dean Alan Iley, Chesapeake, VA (US); Amaranadha Reddy Kalakada, Frisco, TX (US); Gerald Thompson, Rock Hill, SC (US); Sai Kishan Alapati, West Windsor, NJ (US); Timothy John Kearney, Laguna Niguel, CA (US); Uma Sheela, Plano, TX (US); Charles Dewayne Burhenn, Columbus, GA (US); Shannon Swaim, Litchfield Park, AZ (US); Christopher Edwards, Weston, CT (US); Huy Tran, Hockessin, DE (US)

(21) Appl. No.: 17/158,178

(22) Filed: Jan. 26, 2021

(51) Int. Cl. G06Q 20/10; G06Q 40/02

(52) U.S. Cl. CPC G06Q 20/108; G06Q 40/02

(57) ABSTRACT

Systems and arrangements for event analysis and processing control are provided. In some examples, a request for a deposit may be received by a financial institution. The deposit may include deposit data, such as an amount, a payer, a routing number associated with a financial institution of the payer, a payee name, an account of the payee, and the like. The deposit data may be analyzed to determine whether the deposit qualifies for modified processing. If so, an account associated with the payee may be evaluated to determine a current balance of the account. If the account balance meets predetermined criteria, an instruction modifying the account may be executed. The deposit may then be processed. Accounts flagged for modified processing may be evaluated to determine whether the time period for modified processing has expired. If so, instructions causing further modification of the account may be executed.

### BACKGROUND

Aspects of the disclosure relate to electrical computers, systems, and devices performing dynamic event analysis and processing control.

Financial institutions offer a variety of services to customers. In some examples, financial institutions facilitate various types of user deposits. In some examples, it may be desirable to provide a full amount of a deposit to a user, even if the user has a balance below a threshold in his or her account. However, identifying accounts to which this may apply, as well as types of deposits that may qualify for this modified processing, can be difficult. Further, in examples in which a modification to an account is temporary, it may be difficult to identify and remove modifications in a timely manner. Accordingly, aspects described herein are directed to efficient identification of accounts and deposits that qualify for modified processing and controlling aspects of the modified processing.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical problems associated with identifying accounts and/or events for modified processing, executing modified processing and controlling aspects of the modified processing.

In some examples, a request for a deposit may be received by a financial institution. The request may be received via a variety of channels, such as from a self-service kiosk, such as an automated teller machine (ATM), via a banking associate computing device, via a mobile or online banking application, via direct deposit or other electronic funds transfer, or the like. The deposit may include deposit data, such as an amount, a payer, a routing number associated with a financial institution of the payer, a payee name, an account of the payee, and the like.

The deposit data may be analyzed to determine whether the deposit qualifies for modified processing. If so, an account associated with the payee may be evaluated to determine whether it currently has a balance below a threshold. If so, an instruction modifying the account may be executed. In some examples, the instruction may cause modification of the account to a zero balance for a predetermined time period (e.g., number of days, weeks, months, or the like). The deposit may then be processed, thereby making available a full amount of the deposit without offsetting any balance below zero dollars.

In some examples, accounts flagged for modified processing may be evaluated to determine whether the time period for modified processing has expired. Accordingly, account data may be evaluated (e.g., continuously or in batches) to determine whether the time period expired. If so, instructions causing further modification of the account may be executed to return the previous balance to a current balance of the account.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for implementing event analysis and processing control functions in accordance with one or more aspects described herein;

FIGS. 2A-2G depict an illustrative event sequence for implementing event analysis and processing control functions in accordance with one or more aspects described herein;

FIG. 3 depicts an illustrative method for implementing and using event analysis and processing control functions according to one or more aspects described herein;

FIG. 4 illustrates one example environment in which various aspects of the disclosure may be implemented in accordance with one or more aspects described herein; and

FIG. 5 depicts an illustrative block diagram of workstations and servers that may be used to implement the processes and functions of certain aspects of the present disclosure in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, financial institutions process various types of deposits for customers every day. The deposits may be received through various channels and may be drawn on accounts of various payers. The deposits may be made using a check, electronic funds transfer, such as direct deposit, or the like.

In some examples, it may be desirable to make a full amount of a deposit available to a user without using the deposit to offset any balance below a threshold, such as zero dollars, in an account of the user. However, identifying accounts for modified processing, identifying deposits eligible for modified processing, and the like, can be difficult.

Aspect described herein relate to identifying deposits and accounts eligible for modified processing. In some examples, deposits associated with a particular routing number of the payer financial institution may be flagged for modified processing. If the user account also qualifies for modified processing, the system may generate and execute an instruction causing modification of the account. For instance, in conventional arrangements, a temporary hold may be placed on a portion or all of a deposit, such as a check deposit, direct deposit, or the like (e.g., to confirm availability of funds, or the like). Accordingly, the hold, which may be considered a debit, may be removed upon processing the deposit. In arrangements described herein, a hold that may be considered a credit may be placed on an amount below a threshold balance, such as a zero-dollar balance for an account. The hold may act as a credit but, in some instances, might not be entered into a ledger for the account. The hold may then cause a zero balance to occur for the account (prior to processing the deposit) and, once the deposit is processed, a current balance may reflect the amount of the deposit.

As discussed herein, the modified processing may be executed for a predetermined time. Various accounts may be monitored and, upon expiration of the predetermined time, an instruction may be executed removing the modified processing and thereby removing the temporary hold. The current balance of the account may then reflect the amount of the hold.

These and various other arrangements will be discussed more fully below.

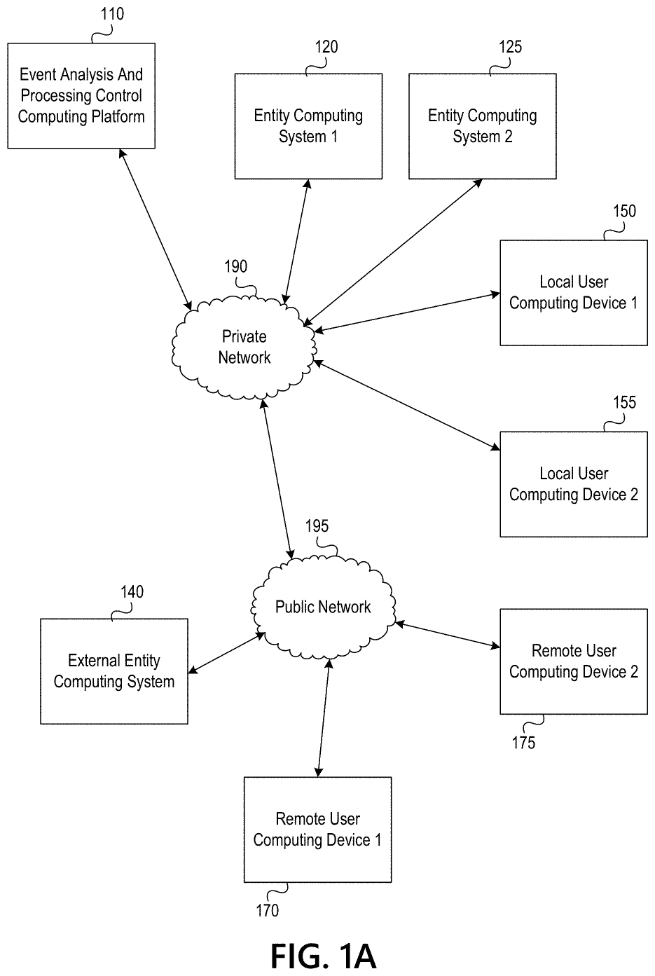

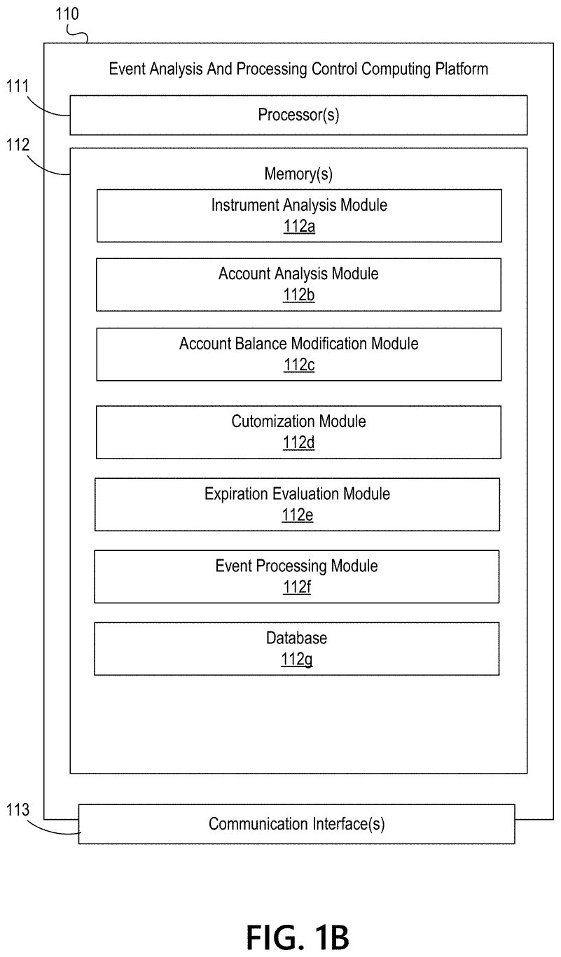

FIGS. 1A-1B depict an illustrative computing environment for implementing and using a multi-computer processing system dynamic event control in accordance with one or more aspects described herein. Referring to FIG. 1A, computing environment 100 may include one or more computing devices and/or other computing systems. For example, computing environment 100 may include event analysis and processing control computing platform 110, entity computing system 1 120, entity computing system 2 125, external entity computing system 140, a first local user computing device 150, a second local user computing device 155, a first remote user computing device 170, and a second remote user computing device 175. Although two entity computing systems 120, 125, two local user computing devices 150, 155, and two remote user computing device 170, 175 are shown, more or fewer devices may be used without departing from the invention.

Further, while FIG. 1A illustrates the devices schematically as being separate devices, one or more systems or devices may be in a same physical device and/or one or more devices may be connected to or otherwise in communication with other devices. For instance, event analysis and processing control computing platform 110 may be part of (e.g., a same physical device) one or more of the entity computing system 1 120 and/or entity computing system 2 125, or may be a separate device in communication with one or more of entity computing system 1 120, entity computing system 2 125, or various other computing devices, as will be discussed herein.

Event analysis and processing control computing platform 110 may be configured to provide intelligent, dynamic, event analysis and processing control functions. For instance, event analysis and processing control computing platform 110 may receive a request for a deposit. In some examples, the request may include an instrument, such as a check. Additionally or alternatively, the request for deposit may be received electronically, such as via direct deposit. The event analysis and processing control computing platform 110 may analyze the request for deposit, and associated deposit data, to determine a source of the funds (e.g., payer), routing number associated with the financial institution on which the deposit is drawn, or the like, to determine whether one or more criteria are met (e.g., whether the funds associated with the requested deposit are received from a particular source, represent a particular type of funds or deposit, or the like). Analyzing the instrument may further include identifying a user and/or account associated with the deposit. Accordingly, in a direct deposit, an account to which the funds are being requested for deposit may be identified or extracted from the data associated with the direct deposit. In arrangements in which the instrument is deposited via a banking associate, self-service kiosk, mobile banking application, or the like, an account associated with the user requested deposit, or identified by the user, may be identified.

In some examples, event analysis and processing control computing platform 110 may analyze the account to determine whether a current balance of the account meets one or more criteria for modified processing. In some examples, a current balance of the account may be evaluated to determine whether is below a threshold balance (e.g., balance below zero dollars). If not, the requested deposit may be processed via traditional or standard event processing channels or processes.

If the account meets the criteria for modified processing, and if the deposit meets one or more criteria for modified processing, the event analysis and processing control computing platform 110 may generate and/or execute one or more instructions to modify an available balance of the account. For instance, in some examples, the event analysis and processing control computing platform 110 may place a hold or credit on the account such that a current balance of the account may appear to be zero dollars. The credit may correspond to an amount that is the difference between zero and the balance of the account below zero dollars. In some examples, a ledger associated with the account might not be modified to reflect this hold or credit. However, the account balance may be modified to reflect the hold and corresponding zero-dollar balance (e.g., prior to processing the deposit).

In some examples, the instruction to modify the available balance of the account may include a predetermined time period or other expiration criteria. Accordingly, upon expiration of the predetermined time period, or upon meeting the other expiration criteria, event analysis and processing control computing platform 110 may generate and/or execute an instruction to further modify the balance of the account to remove the ledger hold, deduct the amount added to bring the account to a zero balance, or the like. For instance, in some examples, the credit may remain in place until an amount corresponding to the amount of the deposit is removed from the account (e.g., spent, withdrawn, or the like). This may cause automatic expiration of the modified processing and may remove the credit.

Accordingly, the arrangements described may be used to enable use of an entire amount of the requested deposit without drawing down or offsetting a balance below a threshold, such as zero dollars, in the account. This may enable users who have a balance below a threshold amount to use the full amount of the payment without impacting their actual balance, unless they should decide to opt out of the program and offset the balance below the threshold with the payment, as will be discussed more fully herein.

Entity computing system 1 120 and entity computing system 2 125 may be computing devices associated with the entity or enterprise organization implementing the event analysis and processing control computing platform 110. For instance, entity computing system 1 120 and/or entity computing system 2 125 may include systems and/or devices for hosting and/or executing applications for processing events, controlling account balances and/or ledgers, storing user data, and the like.

External entity computing system 140 may include one or more systems, devices, or the like, associated with an entity other than the entity implementing the event analysis and processing control computing platform 110. For instance, external entity computing system 140 may be a system associated with an entity that may act as a source of the funds being deposited (e.g., a government entity) and may facilitate or execute transfer of the funds (e.g., by direct deposit or other electronic funds transfer).

Local user computing device 150, 155 and remote user computing device 170, 175 may be configured to communicate with and/or connect to one or more computing devices or systems shown in FIG. 1A. For instance, local user computing device 150, 155 may communicate with one or more computing systems or devices via network 190, while remote user computing device 170, 175 may communicate with one or more computing systems or devices via network 195. In some examples, local user computing device 150, 155 may include one or more servers, computing platforms, desktop computers, laptop computers, mobile devices, or the like that may be used to access the event analysis and processing control computing platform 110, entity computing system 1 120, entity computing system 2 125, or the like to control parameters associated with the devices or systems, update or execute rules, modify settings and the like. In some examples, one or more of local user computing device 150 and/or local user computing device 155 may be or include a banking associate computing device (e.g., at a banking location). Accordingly, a user may request deposit by presenting an instrument, such as a check, to the banking associate who may then facilitate analysis of the instrument and deposit by the local user computing device 150 and/or 155.

The remote user computing device 170 and remote user computing device 175 may be used to communicate with, for example, one or more systems, computing platforms, devices, or the like, to execute one or more applications that may be implemented by the user to facilitate the deposit. For instance, a user may request deposit of the funds associated with the instrument via an on-line application, mobile banking application, or the like, executing on remote user computing device 170, remote user computing device 175, or the like. Accordingly, remote user computing device 170, 175 may include mobile devices, such as smartphones, tablets, wearable devices, and the like, as well as desktop or other computing devices of a user.

Computing environment 100 also may include one or more computing platforms. For example, and as noted above, computing environment 100 may include event analysis and processing control computing platform 110. As illustrated in greater detail below, event analysis and processing control computing platform 110 may include one or more computing devices configured to perform one or more of the functions described herein. For example, event analysis and processing control computing platform 110 may include one or more computers (e.g., laptop computers, desktop computers, servers, server blades, or the like).

As mentioned above, computing environment 100 also may include one or more networks, which may interconnect one or more of event analysis and processing control computing platform 110, entity computing system 1 120, entity computing system 2 125, external entity computing system 140, local user computing device 150, local user computing device 155, remote user computing device 170, and/or remote user computing device 175. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, event analysis and processing control computing platform 110, entity computing system 1 120, entity computing system 2 125, local user computing device 150, and local user computing device 155, may be associated with an organization or entity (e.g., a financial institution), and private network 190 may be associated with and/or operated by the organization, and may include one or more networks (e.g., LANs, WANs, virtual private networks (VPNs), or the like) that interconnect event analysis and processing control computing platform 110, entity computing system 1 120, entity computing system 2 125, local user computing device 150, local user computing device 155, and one or more other computing devices and/or computer systems that are used by, operated by, and/or otherwise associated with the organization. Public network 195 may connect private network 190 and/or one or more computing devices connected thereto (e.g., event analysis and processing control computing platform 110, entity computing system 1 120, entity computing system 2 125, local user computing device 150, local user computing device 155) with one or more networks and/or computing devices that are not associated with the organization. For example, external entity computing system 140, remote user computing device 170, remote user computing device 175, might not be associated with an organization that operates private network 190 (e.g., because external entity computing system 140, remote user computing device 170, remote user computing device 175, may be owned, operated, and/or serviced by one or more entities different from the organization that operates private network 190, one or more customers of the organization, one or more employees of the organization, public or government entities, and/or vendors of the organization, rather than being owned and/or operated by the organization itself), and public network 195 may include one or more networks (e.g., the internet) that connect external entity computing system 140, remote user computing device 170, remote user computing device 175, to private network 190 and/or one or more computing devices connected thereto (e.g., event analysis and processing control computing platform 110, entity computing system 1 120, entity computing system 2 125, local user computing device 150, local user computing device 155).

Referring to FIG. 1B, event analysis and processing control computing platform 110 may include one or more processors 111, memory 112, and communication interface 113. A data bus may interconnect processor(s) 111, memory 112, and communication interface 113. Communication interface 113 may be a network interface configured to support communication between event analysis and processing control computing platform 110 and one or more networks (e.g., private network 190, public network 195, or the like). Memory 112 may include one or more program modules having instructions that when executed by processor(s) 111 cause event analysis and processing control computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of event analysis and processing control computing platform 110 and/or by different computing devices that may form and/or otherwise make up event analysis and processing control computing platform 110.

For example, memory 112 may have, store and/or include an instrument analysis module 112a. Instrument analysis module 112a may store instructions and/or data that may cause or enable the event analysis and processing control computing platform 110 to receive a request for a deposit (e.g. via an instrument such as a check, direct deposit, electronic funds transfer, or the like). The instrument analysis module 112a may analyze the instrument to identify a source of the deposit, a routing number associated with a financial institution or other entity on which the deposit is drawn, a payee or user to whom the deposit is being made, and the like. In some examples, optical character recognition (OCR) may be used to extract data, such as the items identified above, from the instrument.

The extracted or identified data may then be further analyzed to determine whether it meets one or more criteria. For instance, the instrument analysis module 112a may analyze the extracted data and compare it to one or more alternate processing criteria established to modify processing or analysis of instruments meeting the criteria. For example, if the routing number associated with the instrument matches a routing number associated with an entity that is flagged for modified processing, the instrument may be identified as being eligible for modified processing, such as a modified compensating adjustment.

Event analysis and processing control computing platform 110 may further have, store and/or include an account analysis module 112b. Account analysis module 112b may store instructions and/or data that may cause or enable event analysis and processing control computing platform 110 to, based on data extracted from the instrument or other deposit request, identify an account to which the deposit will be deposited or to which the deposit is requested. For instance, a user may identify a desired account to which the deposit will be made via a mobile or online banking application (if mobile instrument deposit), via pre-defined account information (e.g., if direct deposit), via user input to a self-service kiosk (e.g., by selecting a desired account at, for instance, an automated teller machine), or the like. The account may then be analyzed, e.g., by account analysis module 112b, to determine a current balance of the account, whether the account has a balance below a threshold, and the like. In some examples, if the account meets one or more criteria, such as a balance below a threshold, and the instrument qualifies for modified processing, deposit of the instrument may be performed using modified processing functions, such as a modified compensating adjustment as described herein.

Event analysis and processing control computing platform 110 may further have, store and/or include account balance modification module 112c. Account balance modification module 112c may store instructions and/or data that may cause or enable the event analysis and processing control computing platform 110 to modify or adjust a balance associated with an account designated for modified processing. In some examples, an account meeting one or more criteria, such as having a balance below a threshold, may be modified to place a temporary credit or hold on the account. The credit may enable a balance of the account to be modified to a predetermined balance (e.g., zero balance) without, for instance, modifying a ledger for the account. For instance, a posting system which may update account balances based on one or more events or transactions, may recognize the temporary credit and not modify a ledger for that account. When the temporary credit is removed, the ledger may be updated via the posting system. Accordingly, upon modifying the balance and processing a deposit, a full amount of the deposit may, via modified processing, be available to the user (e.g., without offsetting any balance below a threshold).

As discussed herein, the modifications to the accounts designated for modified processing may be temporary modifications that may expire after a predetermined time, on a predetermined date, after a predetermined triggering event occurs, or the like. At that time, further modifications may be made to return the previous balance below the threshold (e.g., temporary credit removed, or the like).

Event analysis and processing control computing platform 110 may further have, store and/or include customization module 112d. Customization module 112d may store instructions and/or data that may cause or enable the event analysis and processing control computing platform 110 to receive one or more customization inputs from, for example, local user computing device 150, local user computing device 155, remote user computing device 170, remote user computing device 175, or the like. For instance, a system administrator or other entity user may designate a predetermined time period (e.g., number of days, weeks, months or the like) for which the modification should remain before expiring. In some examples, the entity user may designate a particular date (e.g., month, day and year) on which the modification may expire. Further, the administrator may identify one or more triggering events that may cause the modified processing to expire. For instance, once an amount corresponding to the amount of the qualifying deposit is withdrawn from the account, the modified processing may expire. Additionally or alternatively, a user may request or opt out of the arrangements described herein, thereby permitting the system to offset any balance below a threshold, with the amount of the requested deposit. Various other customization options may be used without departing from the invention.

Event analysis and processing control computing platform 110 may further have, store and/or include expiration evaluation module 112e. Expiration evaluation module 112e may store instructions and/or data that may cause or enable the event analysis and processing control computing platform 110 to evaluate modified accounts or balances, compare a time period of the modification or a current date to an expiration time period or date and, if the modification period has expired, expiration evaluation module 112e may generate and/or execute an instruction further modifying the account or balance. For instance, the expiration evaluation module 112e may generate and/or execute an instruction removing the temporary hold or credit and thereby reinstating the previous balance below a threshold. In another example, the expiration evaluation module 112e may evaluate a current balance of the account to determine whether one or more triggering events have occurred and, if so, may execute an instruction to further modify the account.

Event analysis and processing control computing platform 110 may further have, store and/or include event processing module 112f. Event processing module 112f may store instructions and/or data that may cause or enable event analysis and processing control computing platform 110 to process a request for deposit, either via traditional, standard processing functions or via modified processing functions, as described herein. The event processing module 112f may communicate with, transmit and/or receive data from, or the like, one or more entity computing systems, such as entity computing system 1 120, entity computing system 2 125, or the like, to facilitate processing of the requested deposit using functions identified based on the instrument and account.

Event analysis and processing control computing platform 110 may further have, store and/or include one or more databases 112g. Database 112g may store account information, user information, criteria for modified processing, and the like. Data may be retrieved from the database 112g and/or stored in the database 112g (e.g., balances held, and the like).

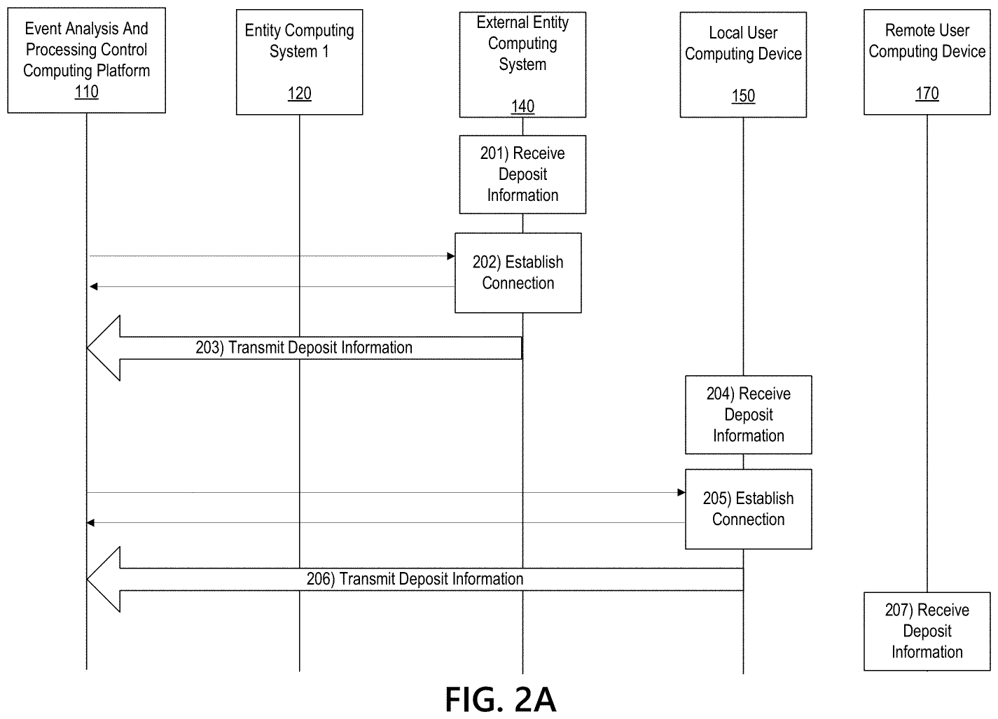

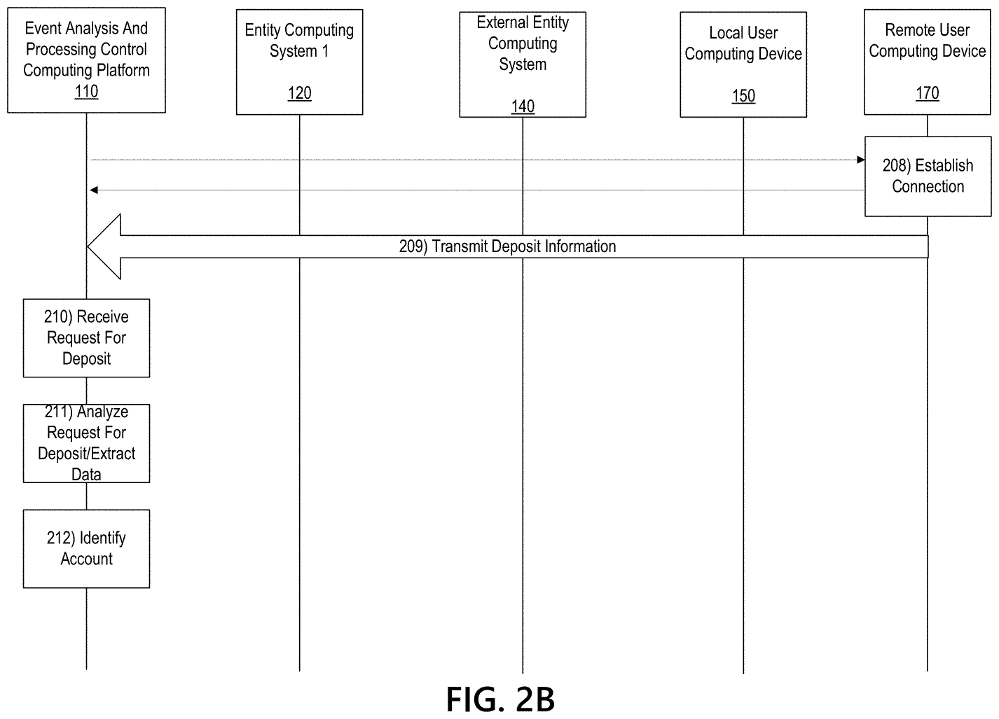

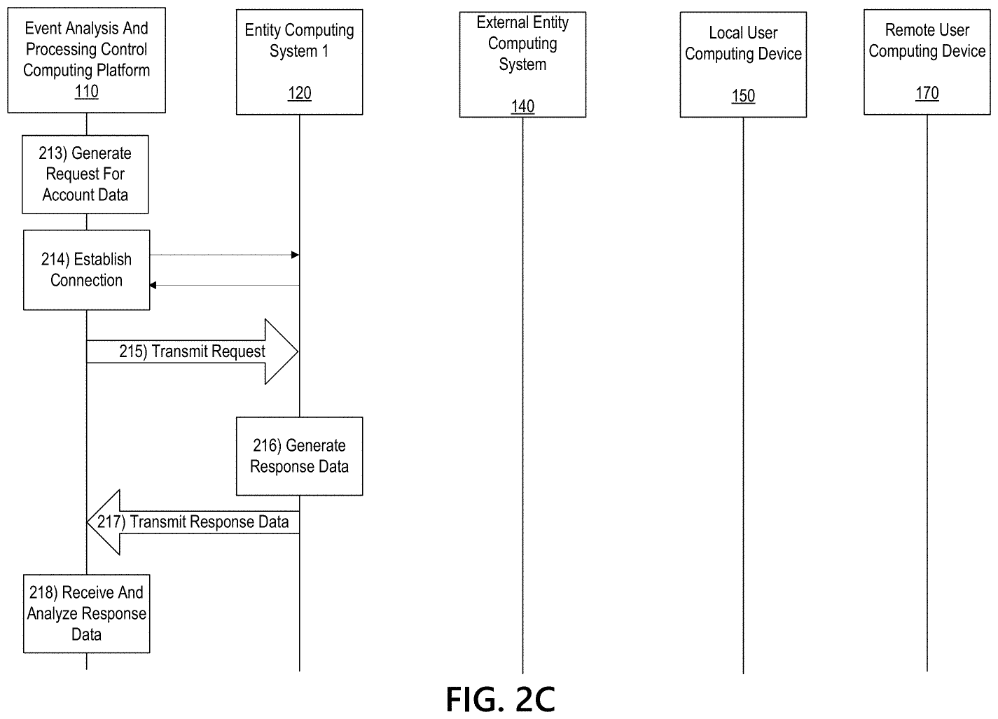

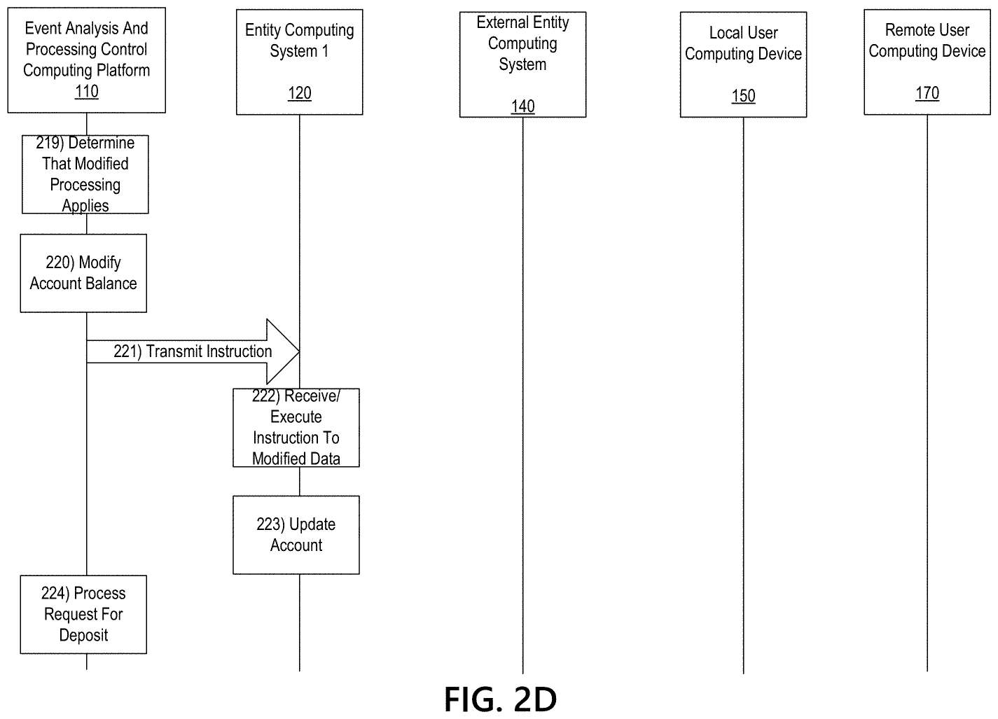

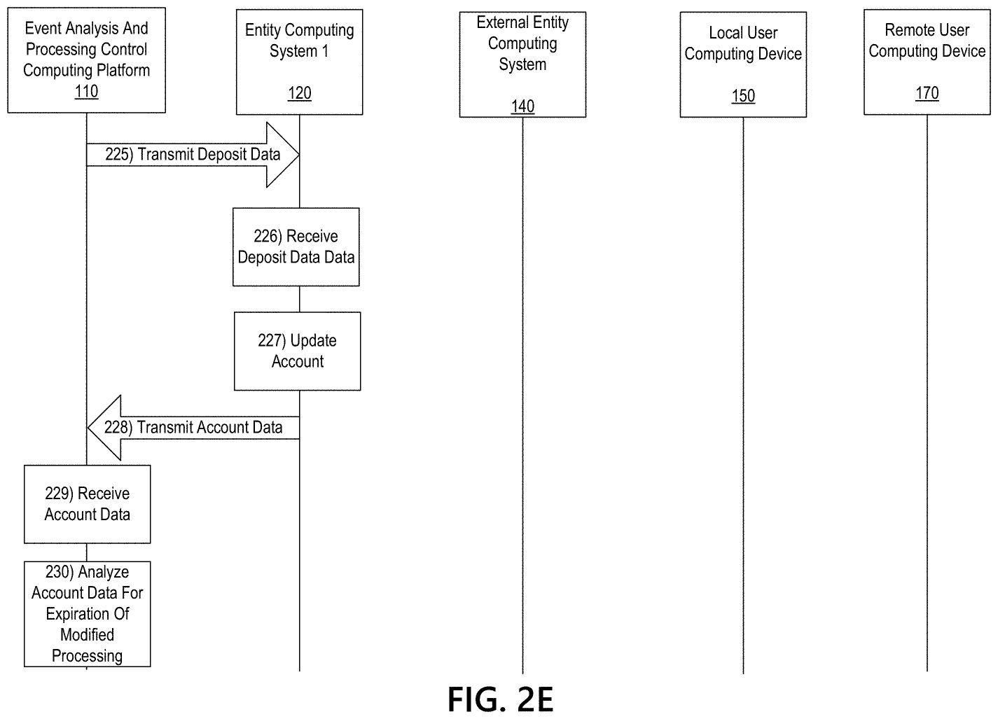

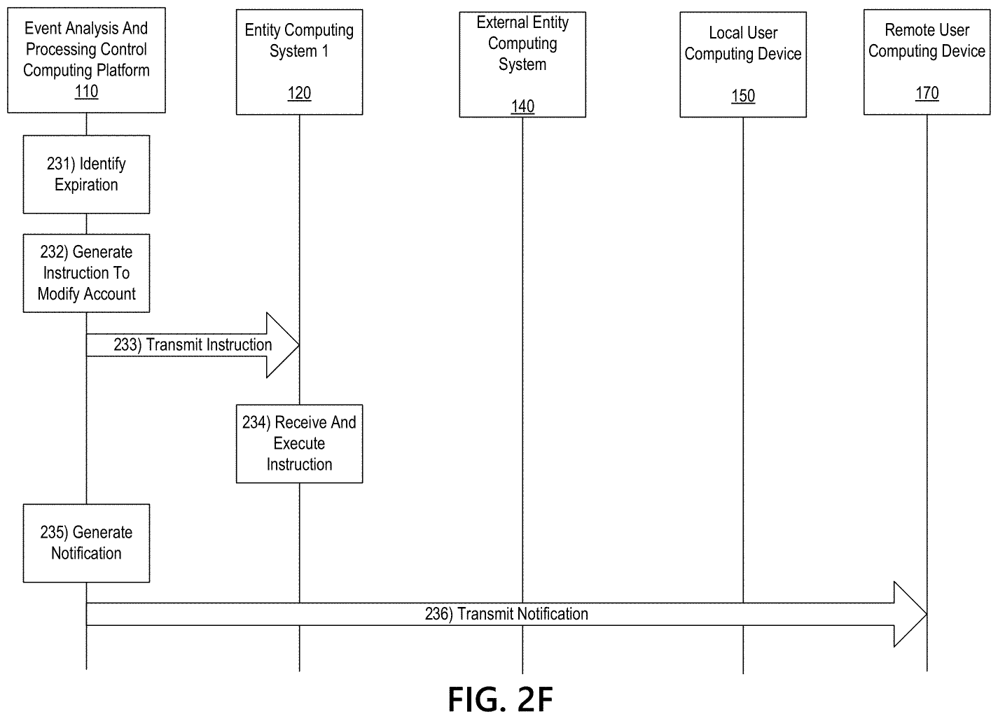

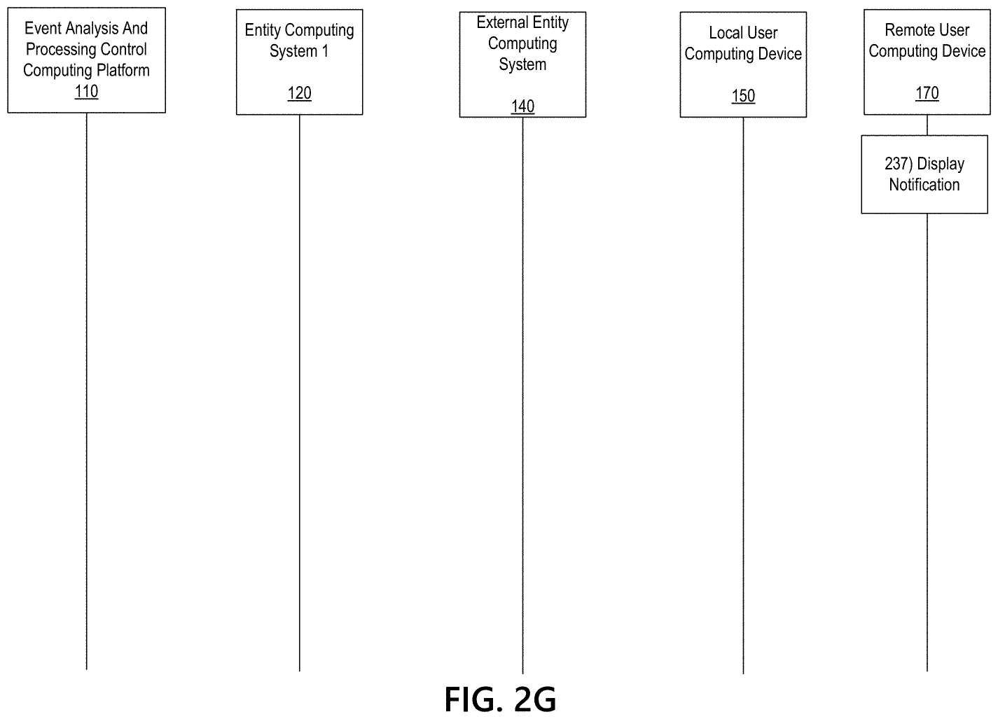

FIGS. 2A-2G depict one example illustrative event sequence for implementing and using event analysis and processing control functions in accordance with one or more aspects described herein. The events shown in the illustrative event sequence are merely one example sequence and additional events may be added, or events may be omitted, without departing from the invention.

To begin the process, a request for deposit may be received via one or more channels (e.g., via direct deposit or electronic funds transfer, via a banking associate at a banking location, via a self-service kiosk, via a mobile or on-line application executing on a user device, or the like). For instance, at step 201, deposit data and/or request for deposit may be received by an external entity computing system 140 (e.g., other outside entity, government entity, or the like). The deposit data may include an amount of deposit, routing number of the financial or other institution making the deposit (payer), name of payee, account number associated with user account, routing number associated with the financial institution of the user account, and the like.

At step 202, a connection may be established between the external entity computing system 140 and event analysis and processing control computing platform 110. For instance, a first wireless connection may be established between event analysis and processing control computing platform 110 and external entity computing system 140. Upon establishing the first wireless connection, a communication session may be initiated between event analysis and processing control computing platform 110 and external entity computing system 140.

At step 203, a request for deposit and the received deposit data may be transmitted from external entity computing system 140 to event analysis and processing control computing platform 110. For instance, the request for deposit and deposit data may be transmitted during the communication session initiated upon establishing the first wireless connection.

At step 204, a request for deposit and/or deposit data may be received by a local user computing device 150. Local user computing device 150 may include a computing device associated with one or more banking associates (e.g., at a banking location), a self-service kiosk associated with a financial institution and configured to receive deposits, such as an automated teller machine (ATM), automated teller assistant (ATA), or the like. The deposit data may include an amount of deposit, routing number of the financial or other institution making the deposit (payer), name of payee, account number associated with user account, routing number associated with the financial institution of the user account, and the like.

At step 205, a connection may be established between the local user computing device 150 and event analysis and processing control computing platform 110. For instance, a second wireless connection may be established between event analysis and processing control computing platform 110 and local user computing device 150. Upon establishing the second wireless connection, a communication session may be initiated between event analysis and processing control computing platform 110 and local user computing device 150.

At step 206, a request for deposit and the received deposit data may be transmitted from local user computing device 150 to event analysis and processing control computing platform 110. For instance, the request for deposit and deposit data may be transmitted during the communication session initiated upon establishing the second wireless connection.

At step 207, a request for deposit and/or deposit data may be received by a remote user computing device 170. Remote user computing device 170 may be a user computing device, such as smartphone, tablet, wearable device, laptop, desktop computer, or the like. Accordingly, the request for deposit may be made via an online application or mobile application executing on remote user computing device 170. The deposit data may include an amount of deposit, routing number of the financial or other institution making the deposit (payer), name of payee, account number associated with user account, routing number associated with the financial institution of the user account, and the like.

With reference to FIG. 2B, at step 208, a connection may be established between the remote user computing device 170 and event analysis and processing control computing platform 110. For instance, a third wireless connection may be established between event analysis and processing control computing platform 110 and remote user computing device 170. Upon establishing the third wireless connection, a communication session may be initiated between event analysis and processing control computing platform 110 and remote user computing device 170.

At step 209, a request for deposit and the received deposit data may be transmitted from remote user computing device 170 to event analysis and processing control computing platform 110. For instance, the request for deposit and deposit data may be transmitted during the communication session initiated upon establishing the third wireless connection.

Although requests for deposit are shown as received from each of external entity computing system 140, local user computing device 150 and remote user computing device 170, requests for deposit and deposit data may be received from fewer devices, more devices, other combinations of devices, a single device, or the like, without departing from the invention. In some examples, the system may interrogate all requests for events via all available channels (e.g., of a certain type, such as deposits) to evaluate whether criteria are met.

At step 210, the request for deposit and associated deposit data may be received by event analysis and processing control computing platform 110. For instance, the request for deposit and associated deposit data may be received via one or more channels described herein (e.g., direct deposit, banking associate device, self-service kiosk, user device, or the like).

At step 211, the request for deposit and deposit data may be analyzed and data extracted from the request. For instance, data associated with a routing number of the payer entity, account number or name of payee, and the like, may be extracted. The data may be analyzed and compared to one or more modified processing criteria. For instance, if the routing number of the financial institution on which the instrument is drawn, or from which the deposit is being received, matches routing numbers associated with modified processing, the request for deposit may be flagged for modified processing and alternate processing functions may be performed when processing the deposit. In another example, if a name of a payer entity matches an entity for modified processing, the request for deposit may be flagged and modified processing may be initiated.

At step 212, an account to which the funds will be deposited is identified. In some examples, the account may be predefined based on information provided by the user, e.g., for direct deposit. Additionally or alternatively, the user may identify or select an account for the deposit via the banking associate, self-service kiosk, mobile or online application, or the like.

With reference to FIG. 2C, at step 213, based on the identified account information, a request for current account data may be generated. For instance, a request for a current account balance may be generated.

At step 214, a connection may be established between the event analysis and processing control computing platform 110 and entity computing system 1 120. For instance, a fourth wireless connection may be established between event analysis and processing control computing platform 110 and entity computing system 1 120. Upon establishing the fourth wireless connection, a communication session may be initiated between event analysis and processing control computing platform 110 and entity computing system 1 120.

At step 215, the request for account data may be transmitted from the event analysis and processing control computing platform 110 to the entity computing system 1 120. For instance, the request for account data may be transmitted during the communication session initiated upon establishing the fourth wireless connection.

At step 216, the request for account data may be received and processed and account data may be extracted from one or more systems, databases, or the like. The extracted data may be used to generate response data including the requested account data.

At step 217, the response data may be transmitted from entity computing system 1 120 to event analysis and processing control computing platform 110.

At step 218, the response data including the requested account data may be received by event analysis and processing control computing platform 110 and analyzed. For instance, the current balance of the account may be analyzed to determine whether it meets one or more criteria, such as a balance below a particular or predetermined threshold (e.g., balance below zero dollars). If so, the account may be flagged for modified processing if, for example, the requested deposit is also eligible for modified processing.

With reference to FIG. 2D, at step 219, based on the account balance and deposit data, a determination may be made that modified processing applies to the requested deposit. Accordingly, one or more modified processing functions may be activated or initiated.

At step 220, an instruction to modify a current balance of the account may be generated. For instance, event analysis and processing control computing platform 110 may generate an instruction to modify the current balance of the account, which may, for example, include a balance below a predetermined threshold, to which the funds are being deposited. In some examples, modifying the account balance may include placing a temporary hold (e.g., a credit) on the identified account balance below a threshold such that the balance of the account will be modified to zero for purposes of the requested deposit.

At step 221, the generated instruction may be transmitted from the event analysis and processing control computing platform 110 to the entity computing system 1 120. For instance, the instruction may be generated during the communication session initiated upon establishing the fourth wireless connection. Alternatively, an additional connection and communication session may be established and initiated.

At step 222, the instruction may be received and executed by entity computing system 1 120. Accordingly, upon executing the instruction, the account data may be modified in step 223 and the account balance may be updated (e.g., to a predetermined amount, such as zero, based on the executed instruction).

At step 224, event analysis and processing control computing platform 110 may cause processing of the requested deposit. For instance, the deposit may be executed and funds transferred from the payer account to the payee account (e.g., the modified payee account). Accordingly, an instruction causing the balance of the user account to be modified to reflect the deposited funds (e.g., the modified zero balance may now reflect the amount of the deposit) may be generated.

With reference to FIG. 2E, at step 225, deposit data to update the user account may be transmitted from the event analysis and processing control computing platform 110 to entity computing system 1 120. The deposit data may be transmitted during the established communication session or via a new communication session initiated upon establishing another wireless connection.

At step 226, the deposit data and associated instruction may be received and executed by entity computing system 1 120. At step 227, the account data may be updated based on the executed instruction. For instance, the modified zero balance may now reflect the amount of the deposit. Thus, the current balance of the account at that time (e.g., without any intervening transactions) may be the amount of the deposit.

As discussed herein, modifications to the account may be temporary modifications that may expire after a predetermined time, on a predetermined date, or the like. Accordingly, after the modified processing of the deposit, one or more accounts that were flagged for modified processing may be monitored to determine whether the modified processing time period has expired.

Accordingly, at step 228, account data may be received from entity computing system 1 120. The account data may be transmitted on a continuous basis for real-time or near real-time analysis, in batch transfer operations, or the like. In some examples, the account data may include data for all accounts flagged for modified processing, for a portion (e.g., fewer than all accounts) of the accounts flagged for modified processing, or the like.

At step 229, the account data may be received by event analysis and processing control computing platform 110. At step 230, the received data may be analyzed to determine whether modified processing has expired for any of the accounts. For instance, expiration data associated with each account may be compared to current data to determine whether modified processing has expired. For example, for accounts on which modified processing is set to expire on a predetermined date, the predetermined date for each account may be compared to a current date to determine whether modified processing has expired. In another example, for accounts on which modified processing is set to expire after a predetermined time period from a particular date, the current time elapsed between the starting date and the current date may be determined and compared to the predetermined time period to determine whether modified processing has expired. In still another example, accounts for which modified processing is configured to expire upon withdrawal of a predetermined amount of funds may compare a balance to the amount of funds to determine whether modified processing is expired.

With reference to FIG. 2F, at step 231, based on the analysis performed at step 230, one or more accounts for which modified processing has expired may be identified.

At step 232, an instruction to further modify the expired accounts may be generated. For instance, an instruction to remove a hold placed on the balance below a predetermined threshold of an account may be generated. In another example, an instruction to subtract a difference between a zero balance and the previous balance below a threshold from a current balance of the account may be generated.

At step 233, the generated instruction(s) may be transmitted from event analysis and processing control computing platform 110 to entity computing system 1 120 (e.g., during a current or newly initiated communication session).

At step 234, the instruction(s) may be received by entity computing system 1 120 and executed. Executing the instructions may cause modification of one or more account balances.

At step 235, a notification to the user associated with a modified account may be generated. The notification may indicate that modified processing for the account has expired and that additional account modifications may be made.

At step 236, the notification may be transmitted from the event analysis and processing control computing platform 110 to the remote user computing device 170. In some examples, the notification may be transmitted to a pre-registered computing device associated with the user. The notification may be transmitted during the communication session initiated upon establishing the third wireless connection. In other examples, another wireless connection may be established and communication session initiated.

With reference to FIG. 2G, at step 237, the notification may be received by remove user computing device 170 and displayed by a display of the device.

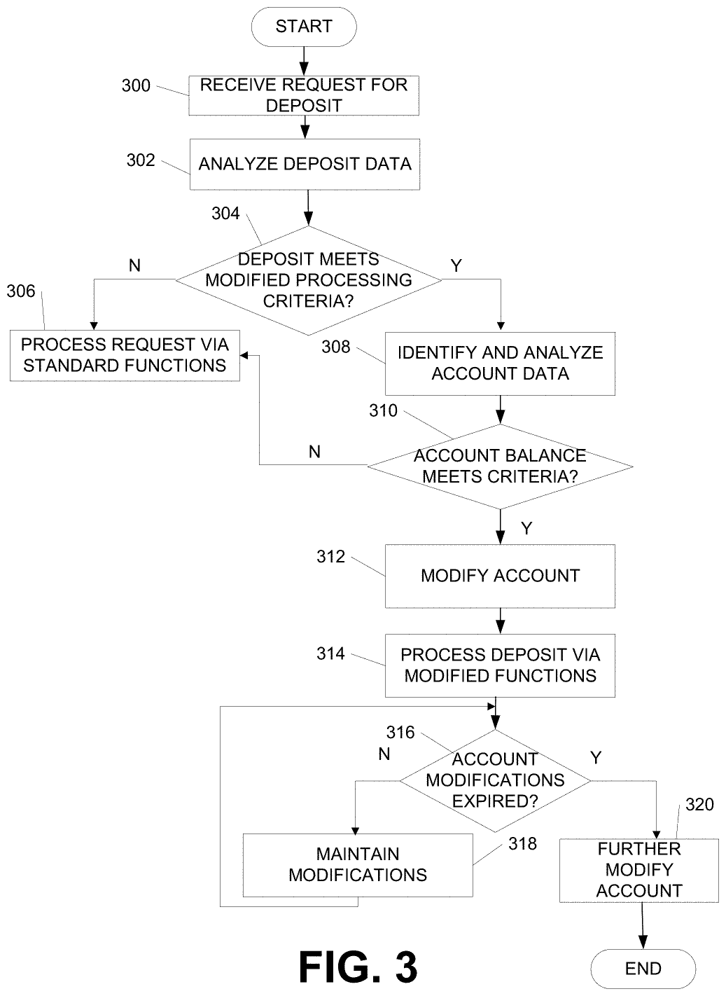

FIG. 3 is a flow chart illustrating one example method of implementing event analysis and processing control functions according to one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described.

At step 300, a request for deposit may be received. The request for deposit may be received via one or more channels, such as via a self-service kiosk, such as an ATM, from a banking associate computing device, via direct deposit or other electronic funds transfer from the payer, via an online or mobile banking application executing on a user computing device, or the like. In some examples, the request for deposit may include deposit data, such as payee name, payer name, routing number associated with the financial institution from which the funds are received, routing number of the financial institution to which the funds may be deposited, or the like.

At step 302, the deposit data may be analyzed. For instance, the deposit data may be compared to one or more modified processing criteria, such as a particular payer, routing number, or the like, flagged for modified processing.

At step 304, a determination may be made as to whether the deposit data meets criteria for modified processing. If not, the requested deposit may be processed using standard processing functions at step 306.

If, at step 304, the deposit data does meet the criteria for modified processing, account data associated with the user account to which the funds will be deposited may be identified and analyzed at step 308. For instance, a user account may be identified (e.g., from direct deposit information, from user input in requesting the deposit, or the like) and a current balance of the account may be received and analyzed.

At step 310, a determination may be made as to whether a current balance of the identified account meets one or more criteria for modified processing. For example, the balance may be evaluated to determine whether it includes a balance below a threshold. If not, the requested deposit may be processed using standard processing functions at step 306.

If, at step 310, the current balance of the identified account meets one or more criteria, one or more account modifications may be executed at step 312. For instance, a temporary hold (e.g., credit) may be placed on the balance below a threshold of the account such that the account will reflect a zero-dollar balance (e.g., prior to processing the requested deposit).

At step 314, the requested deposit may be processed via the modified processing functions described herein. That is, the deposit may be deposited to the identified account and a balance of the account may be adjusted to reflect the amount of the deposit. Accordingly, based on the modification to move the account to a zero balance, a current balance of the account after depositing the funds may be the amount of the deposit.

At step 316, a determination may be made as to whether modified processing for one or more accounts has expired. If not, the modifications made may be maintained and the process may return to step 316 to further evaluate the account data.

If, at step 316, modified processing for one or more accounts has expired, at step 320, the expired accounts may be further modified (e.g., instructions further modifying the accounts may be generated and executed) to reflect the balance below a threshold that was removed or held (e.g., via the temporary hold or credit) during the earlier modification (e.g., at step 312). For instance, a temporary hold placed on the balance below a threshold may be removed, thereby causing the balance below a threshold to once again be reflected in the account balance to the user.

As discussed above, one or more notifications may be generated and transmitted to a user device indicating account modifications, and the like. In some examples, notifications may be generated upon determining that an account and deposit are eligible for modified processing, upon deposit via modified processing, upon expiration of modified processing, upon expected expiration of modified processing, and the like. In some examples, one or more notifications may include criteria for qualifying for modified processing, an expected expiration date or expiration criteria, and the like.

Accordingly, arrangements described herein enable a system to process deposits to provide a full amount of the deposit to a user without using any portion of the deposit to offset a balance below a threshold. By modifying an account balance, such as to include a compensating adjustment of an amount equal to an amount of the balance below a threshold, the user account may be modified to reflect a zero balance prior to processing of the requested deposit. Use of a temporary hold or credit may enable this compensating adjustment without modifying a ledger associated with the account.

As discussed herein, the compensating adjustment or hold may be provided on a temporary or provisional basis. Accordingly, one or more expiration criteria may be established. After modified processing of a deposit, accounts that qualified for modified processing may be evaluated (e.g., continuously, on a batch basis) to determine whether expiration criteria are met.

Further, a time at which a current balance of an account may be evaluated to determine whether it meets one or more modified processing criteria may vary. For instance, the time at which an account balance is evaluated may vary based on a channel through which a request for deposit was received. For instance, if the request for deposit was made via direct deposit, a time at which the direct deposit was executed may be the time at which the current balance information is retrieved and evaluated. In another example, a time at which a user deposits a check or instrument to a self-service kiosk or provides the check to the banking associate for deposit may be the time at which the current balance information is retrieved and evaluated for qualifying criteria.

Aspects described herein are discussed in the context of a request for deposit. However, in some examples, a request for deposit may include a request to, for instance, cash a check (e.g., receive funds in an amount corresponding to the amount of the check).

As discussed herein, the arrangements described herein may include an option for the user to opt out of modified processing. In examples in which the user opts out of the modified processing, the amount of deposit may be used to offset any balance below a threshold on the account.

In some examples, arrangements described herein may be coupled to unauthorized activity analysis. For instance, as requests for events are evaluated for unauthorized activity, that data and analysis may be leveraged to identify accounts and or requests for deposit that qualify for modified processing.

The arrangements described herein may be flexible and customizable in order to comply with various regulatory or government requirements or guidelines.

Further, while arrangements described herein are directed to evaluating accounts to determine whether one or more criteria are met, such as having a balance below a threshold (e.g., of any amount), in some examples, one or more thresholds may be implemented to adjust modified processing or applicability of modified processing based on the thresholds. For instance, if an account includes a balance greater than a certain threshold amount, the account might not be eligible for modified processing. In some examples, the threshold may be based on varying factors, such as type of customer or user (e.g., commercial versus consumer or personal), length of time as a customer, type of account, or the like.

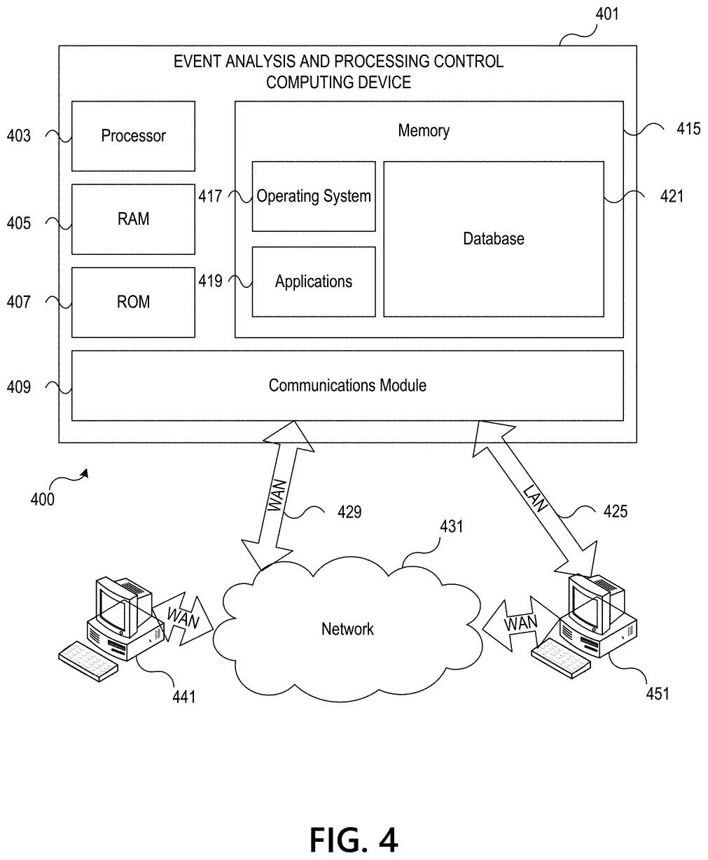

FIG. 4 depicts an illustrative operating environment in which various aspects of the present disclosure may be implemented in accordance with one or more example embodiments. Referring to FIG. 4, computing system environment 400 may be used according to one or more illustrative embodiments. Computing system environment 400 is only one example of a suitable computing environment and is not intended to suggest any limitation as to the scope of use or functionality contained in the disclosure. Computing system environment 400 should not be interpreted as having any dependency or requirement relating to any one or combination of components shown in illustrative computing system environment 400.

Computing system environment 400 may include event analysis and processing control computing device 401 having processor 403 for controlling overall operation of event analysis and processing control computing device 401 and its associated components, including Random Access Memory (RAM) 405, Read-Only Memory (ROM) 407, communications module 409, and memory 415. Event analysis and processing control computing device 401 may include a variety of computer readable media. Computer readable media may be any available media that may be accessed by event analysis and processing control computing device 401, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by event analysis and processing control computing device 501.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on event analysis and processing control computing device 401. Such a processor may execute computer-executable instructions stored on a computer-readable medium.

Software may be stored within memory 415 and/or storage to provide instructions to processor 403 for enabling event analysis and processing control computing device 401 to perform various functions as discussed herein. For example, memory 415 may store software used by event analysis and processing control computing device 401, such as operating system 417, application programs 419, and associated database 421. Also, some or all of the computer executable instructions for event analysis and processing control computing device 401 may be embodied in hardware or firmware. Although not shown, RAM 405 may include one or more applications representing the application data stored in RAM 405 while event analysis and processing control computing device 401 is on and corresponding software applications (e.g., software tasks) are running on event analysis and processing control computing device 401.

Communications module 409 may include a microphone, keypad, touch screen, and/or stylus through which a user of event analysis and processing control computing device 401 may provide input, and may also include one or more of a speaker for providing audio output and a video display device for providing textual, audiovisual and/or graphical output. Computing system environment 400 may also include optical scanners (not shown).

Event analysis and processing control computing device 401 may operate in a networked environment supporting connections to one or more remote computing devices, such as computing devices 441 and 451. Computing devices 441 and 451 may be personal computing devices or servers that include any or all of the elements described above relative to event analysis and processing control computing device 401.

The network connections depicted in FIG. 4 may include Local Area Network (LAN) 425 and Wide Area Network (WAN) 429, as well as other networks. When used in a LAN networking environment, event analysis and processing control computing device 401 may be connected to LAN 425 through a network interface or adapter in communications module 409. When used in a WAN networking environment, event analysis and processing control computing device 401 may include a modem in communications module 409 or other means for establishing communications over WAN 429, such as network 431 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

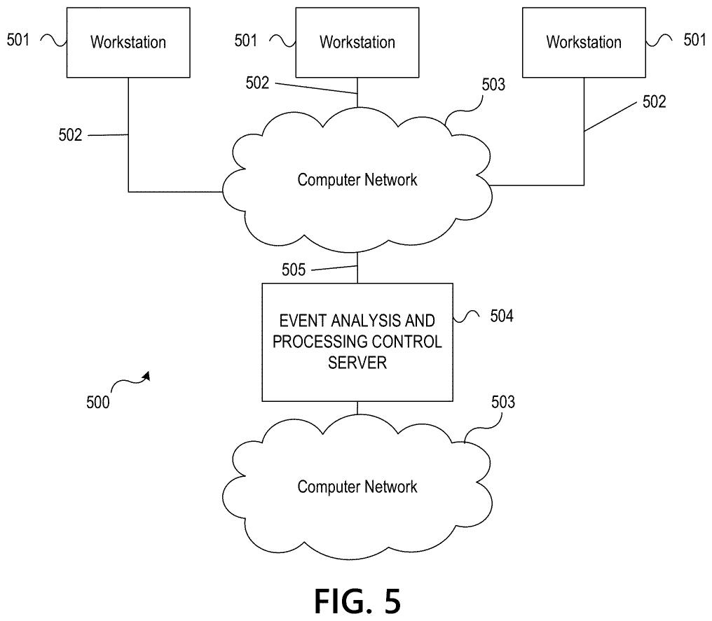

FIG. 5 depicts an illustrative block diagram of workstations and servers that may be used to implement the processes and functions of certain aspects of the present disclosure in accordance with one or more example embodiments. Referring to FIG. 5, illustrative system 500 may be used for implementing example embodiments according to the present disclosure. As illustrated, system 500 may include one or more workstation computers 501. Workstation 501 may be, for example, a desktop computer, a smartphone, a wireless device, a tablet computer, a laptop computer, and the like, configured to perform various processes described herein. Workstations 501 may be local or remote, and may be connected by one of communications links 502 to computer network 503 that is linked via communications link 505 to event analysis and processing control server 504. In system 500, event analysis and processing control server 504 may be a server, processor, computer, or data processing device, or combination of the same, configured to perform the functions and/or processes described herein. Server 504 may be used to receive a request for deposit, evaluate the deposit to determine whether it meets modified processing criteria, evaluate an account to determine whether it includes a balance below a threshold, modify an account, process the deposit, evaluate accounts for expiration of modifications, further modify accounts at expiration, and the like.

Computer network 503 may be any suitable computer network including the Internet, an intranet, a Wide-Area Network (WAN), a Local-Area Network (LAN), a wireless network, a Digital Subscriber Line (DSL) network, a frame relay network, an Asynchronous Transfer Mode network, a Virtual Private Network (VPN), or any combination of any of the same. Communications links 502 and 505 may be communications links suitable for communicating between workstations 501 and event analysis and processing control server 504, such as network links, dial-up links, wireless links, hard-wired links, as well as network types developed in the future, and the like.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least a first processor;
a communication interface communicatively coupled to the at least a first processor; and
a memory storing computer-readable instructions that, when executed by the at least a first processor, cause the computing platform to:
receive a request for a deposit, the request including deposit data;
analyze the deposit data to determine whether it satisfies criteria for modified processing;
responsive to determining that the deposit data does not satisfy criteria for modified processing, process the requested deposit using standard processing;
responsive to determining that the deposit data does satisfy criteria for modified processing, analyze an account balance of an account to which funds associated with the deposit will be deposited to determine whether the account balance meets qualifying criteria;
responsive to determining that the account balance of the account does not meet qualifying criteria, process the request using standard processing and depositing the funds associated with the requested deposit in the account; and
responsive to determining that the account balance of the account does meet qualifying criteria:
execute an instruction to modify the account balance to a zero balance for a predetermined time period; and
process the request for deposit using modified processing and depositing the funds associated with the deposit in the account.

2. The computing platform of claim 1, wherein the predetermined time period is customizable.

3. The computing platform of claim 1, wherein analyzing the account balance of the account to which the funds will be deposited to determine whether the account balance meets qualifying criteria further includes determining that the account balance includes a balance below a threshold and wherein the executing the instruction to modify the account balance to a zero balance includes:
executing an instruction causing a hold on the account balance for the predetermined time period; and
executing an instruction causing a current balance of the account to reflect a zero balance.

4. The computing platform of claim 3, further including instructions that, when executed, cause the computing platform to:
after processing the request for deposit using modified processing:
receiving account data for a plurality of accounts, the account data including the predetermined time period associated with each account;
evaluating the predetermined time period for each account to determine whether it has expired; and
responsive to determining that the predetermined time period for the account has expired, executing an instruction to further modify the account.

5. The computing platform of claim 4, wherein executing the instruction to further modify the account includes:
removing the hold placed on the account balance; and
executing an instruction causing a current balance of the account to include the balance below a threshold.

6. The computing platform of claim 1, wherein the request for deposit is received from one of: a self-service kiosk, an electronic funds transfer, or a mobile banking application executing on a user computing device.

7. The computing platform of claim 1, wherein analyzing the deposit data to determine whether it satisfies criteria for modified processing includes comparing a routing number associated with a financial institution of a payer associated with the deposit to routing numbers flagged for modified processing.

8. A method, comprising:
receiving, by a computing platform having at least one processor and memory, a request for deposit, the request including deposit data;
analyzing, by the at least one processor, the deposit data to determine whether it satisfies criteria for modified processing;
responsive to determining that the deposit data does not satisfy criteria for modified processing, processing, by the at least one processor, the requested deposit using standard processing;
responsive to determining that the deposit data does satisfy criteria for modified processing, analyzing, by the at least one processor, an account balance of an account to which funds associated with the deposit will be deposited to determine whether the account balance meets qualifying criteria;
responsive to determining that the account balance of the account does not meet qualifying criteria, processing, by the at least one processor, the request using standard processing and depositing the funds associated with the deposit in the account; and
responsive to determining that the account balance of the account does meet qualifying criteria:
executing, by the at least one processor, an instruction to modify the account balance to a zero balance for a predetermined time period; and
processing, by the at least one processor, the request for deposit using modified processing and depositing the funds associated with the deposit in the account.

9. The method of claim 8, wherein the predetermined time period is customizable.

10. The method of claim 8, wherein analyzing the account balance of the account to which the funds associated with the deposit will be deposited to determine whether the account balance meets qualifying criteria further includes determining that the account balance includes a balance below a threshold and wherein the executing the instruction to modify the account balance to a zero balance includes:
executing, by the at least one processor, a hold on the account balance for the predetermined time period; and
executing, by the at least one processor, an instruction causing a current balance of the account to reflect a zero balance.

11. The method of claim 10, further including:
after processing the request for deposit using modified processing:
receiving, by the at least one processor, account data for a plurality of accounts, the account data including the predetermined time period associated with each account;
evaluating, by the at least one processor, the predetermined time period for each account to determine whether it has expired; and
responsive to determining that the predetermined time period for the account has expired, executing, by the at least one processor, an instruction to further modify the account.

12. The method of claim 11, wherein executing the instruction to further modify the account includes:
executing, by the at least one processor, an instruction to remove the hold placed on the account balance; and
executing, by the at least one processor, an instruction causing a current balance of the account to include the balance below a threshold.

13. The method of claim 8, wherein the request for deposit is received from one of: a self-service kiosk, an electronic funds transfer, or a mobile banking application executing on a user computing device.

14. The method of claim 8, wherein analyzing the deposit data to determine whether it satisfies criteria for modified processing includes comparing, by the at least one processor, a routing number associated with a financial institution of a payer associated with the deposit to routing numbers flagged for modified processing.

15. One or more non-transitory computer-readable media storing instructions that, when executed by a computing platform comprising at least one processor, memory, and a communication interface, cause the computing platform to:
receive a request for deposit, the request including deposit data;
analyze the deposit data to determine whether it satisfies criteria for modified processing;
responsive to determining that the deposit data does not satisfy criteria for modified processing, process the requested deposit using standard processing;
responsive to determining that the deposit data does satisfy criteria for modified processing, analyze an account balance of an account to which funds associated with the deposit will be deposited to determine whether the account balance meets qualifying criteria;
responsive to determining that the account balance of the account does not meet qualifying criteria, process the request using standard processing and depositing the funds associated with the deposit in the account; and
responsive to determining that the account balance of the account does meet qualifying criteria:
execute an instruction to modify the account balance to a zero balance for a predetermined time period; and
process the request for deposit using modified processing and depositing the funds associated with the deposit in the account.

16. The one or more non-transitory computer-readable media of claim 15, wherein the predetermined time period is customizable.

17. The one or more non-transitory computer-readable media of claim 15, wherein analyzing the account balance of the account to which the funds associated with the deposit will be deposited to determine whether the account balance meets qualifying criteria further includes determining that the account balance includes a balance below a threshold and wherein the executing the instruction to modify the account balance to a zero balance includes:
executing an instructing causing a hold on the account balance for the predetermined time period; and
executing an instruction causing a current balance of the account to reflect a zero balance.

18. The one or more non-transitory computer-readable media of claim 17, further including instructions that, when executed, cause the computing platform to:
after processing the request for deposit using modified processing:
receiving account data for a plurality of accounts, the account data including the predetermined time period associated with each account;
evaluating the predetermined time period for each account to determine whether it has expired; and
responsive to determining that the predetermined time period for the account has expired, executing an instruction to further modify the account.

19. The one or more non-transitory computer-readable media of claim 18, wherein executing the instruction to further modify the account includes:
removing the hold placed on the account balance; and
executing an instruction causing a current balance of the account to include the balance below a threshold.

20. The one or more non-transitory computer-readable media of claim 15, wherein the request for deposit is received from one of: a self-service kiosk, an electronic funds transfer, or a mobile banking application executing on a user computing device.

21. The one or more non-transitory computer-readable media of claim 15, wherein analyze the deposit data to determine whether it satisfies criteria for modified processing includes comparing a routing number associated with a financial institution of a payer associated with the deposit to routing numbers flagged for modified processing.
